(19) United States
(12) Patent Application Publication
(10) Pub. No.: US 2007/0262919 A1
(43) Pub. Date: Nov. 15, 2007

(54) DISPLAY DEVICE AND IMAGE FORMING APPARATUS

(76) Inventor: Junji MATSUZAWA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/744,346

(22) Filed: May 4, 2007

(30) Foreign Application Priority Data
May 12, 2006 (JP) 2006-134135
May 1, 2007 (JP) 2007-120730

(51) Int. Cl. G09G 3/06

(52) U.S. Cl. 345/44

(57) ABSTRACT

An operation panel of an image forming apparatus includes a “START” key, a mode select key, a numeric keypad, a “CLEAR/STOP” key, and a liquid crystal display. The mode select key is used to select functions such as copier, facsimile, printer, and scanner functions. The “START” key includes an indicator that contains a green light-emitting element. The green light-emitting element is arranged under a transparent or half-transparent cover so that a light therefrom can be seen through the cover. The green light-emitting element is, for example, a green light-emitting diode (LED) having an emission wavelength of from 520 nanometers to 530 nanometers. By turning the green LED on, the indicator indicates that the image forming apparatus is available.

### CROSS-REFERENCE TO RELATED APPLICATIONS

The present document incorporates by reference the entire contents of Japanese priority documents, 2006-134135 filed in Japan on May 12, 2006 and 2007-120730 filed in Japan on May 1, 2007.

### BACKGROUND OF THE INVENTION

1. Field of the Invention

The present invention relates to a technology for a person having color vision defects.

2. Description of the Related Art

A conventional display device used for, for example, a monitor of a computer system or a mobile terminal, includes a display screen on which text, an image, and the like are displayed. Generally, a visibility of the display screen varies depending on relative brightness between the screen and a surrounding environment. The visibility of the display screen also varies depending on relative color tone between the screen and its periphery (such as an enclosure of the display device). Therefore, even the same display screen provides a different impression of a screen image because of the type of the enclosure viewed therewith. Consequently, it causes fluctuations in characteristics of screen display, viewability, workability, and the like.

To solve the above problem, for example, Japanese Patent Application Laid-open No. 2004-45466 discloses a display device and a screen adjustment method capable of maintaining the impression from a display screen constant by suppressing the influence of an enclosure upon the view of the display screen.

Japanese Patent Application Laid-open No. 2005-292459 discloses an image forming apparatus that includes a conveying-status indicator lamp located at the bottom of a front side and the like of a paper cassette so that a user need not frequently confirm an operation panel located at the top of the apparatus during job processing. In this case, a light-emitting element such as a light-emitting diode (LED) is used for the indicator lamp. Such a light-emitting element is also used for the display on the operation panel of the image forming apparatus such as a copier. The image forming apparatus is configured to light, for example, a green LED in a standby status or an operable status, and a red LED during execution of a job or in an inoperable status.

According to official statistics, more than three million people have red-green color vision defects in Japan, and more specifically, one out of every 20 males and one out of every 500 females have red-green color vision defects. On a worldwide basis, over 200 million people have color vision defects. The color vision defects are caused not only by an inherited genetic defect but also by aging. It is said that a decline in red-green color discrimination capability appears among people in their seventies, and a decline in blue-yellow color discrimination capability appears among people in their sixties. With the increase of aging population in recent years, it is necessary to promote measures for helping the people having color vision defects (color barrier-free).

In the conventional image forming apparatus, however, both conditions that the apparatus is in the standby or operable status, and the apparatus is currently executing a job or in the inoperable status are indicated by the same portion (indicator) on the operation panel with different colors of lighting. Therefore, people having color vision defects have difficulty to distinguish the conditions of the apparatus from the indicator lamp.

### SUMMARY OF THE INVENTION

It is an object of the present invention to at least partially solve the problems in the conventional technology.

A display device includes a display unit that displays a status of the display device, and a plurality of light-emitting elements that is included in the display unit, and emits light at wavelengths different from one another by a predetermined amount or more.

An image forming apparatus including a display device that includes a display unit that displays a status of the display device, and a plurality of light-emitting elements that is included in the display unit, and emits light at wavelengths different from one another by a predetermined amount or more.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view of an operation panel of an image forming apparatus according to an embodiment of the present invention;

FIG. 2 is an enlarged view of a “START” key on the operation panel;

FIG. 3 is an enlarged view of the “START” key with an indicator lighting up;

FIG. 4 is an enlarged view of the “START” key with another indicator lighting up;

FIG. 5 is an enlarged view of a “COPY” key on the operation panel;

FIG. 6 is an enlarged view of the “COPY” key with an indicator lighting up;

FIG. 7 is an enlarged view of the “COPY” key with another indicator lighting up;

FIG. 8 is a functional block diagram of an operation control unit that controls the operation panel; and

FIG. 9 is a flowchart of an operation control process for driving a red LED or a green LED to light up on the operation panel.

### DETAILED DESCRIPTION OF THE PREFERRED EMBODIMENTS

Exemplary embodiments of the present invention are explained in detail below with reference to the accompanying drawings. The present invention is not limited to the embodiments.

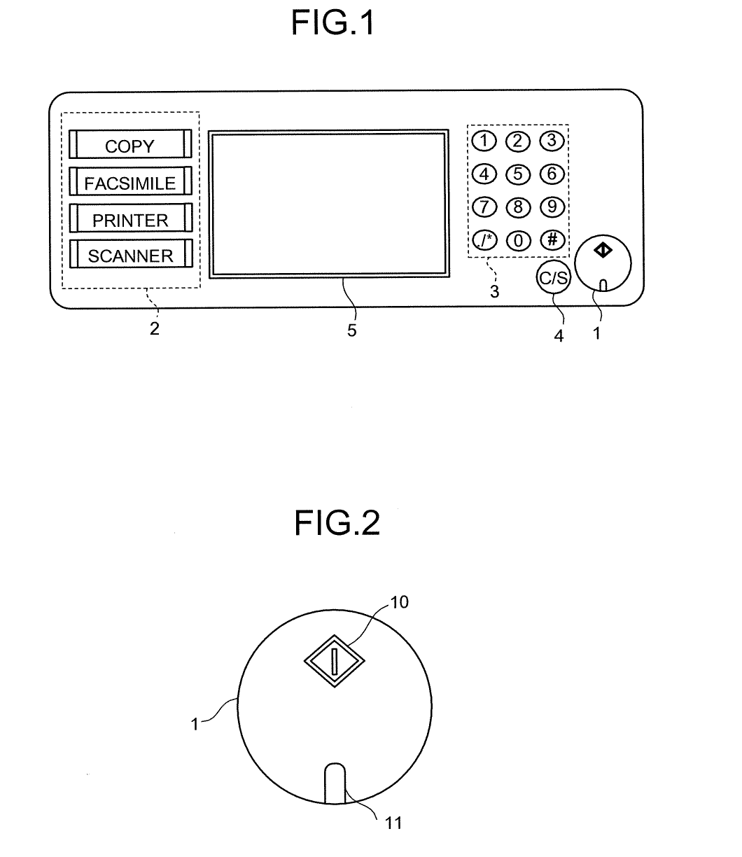

FIG. 1 is a front view of an operation panel of an image forming apparatus according to an embodiment of the present invention. The operation panel includes a “START” key 1, mode select keys 2, a numeric keypad 3, a “CLEAR/STOP” (C/S) key 4, and a liquid crystal display (LCD) 5. The “START” key 1 starts an operation of the image forming apparatus, which is selected with one of the mode select keys 2. The mode select keys 2 are used to select an operation mode or a function of the image forming apparatus, such as “COPY”, “FACSIMILE”, “PRINTER”, and “SCANNER”. According to the embodiment, the “START” key 1 and the mode select keys 2 respectively include indicators for indicating a status of the image forming apparatus.

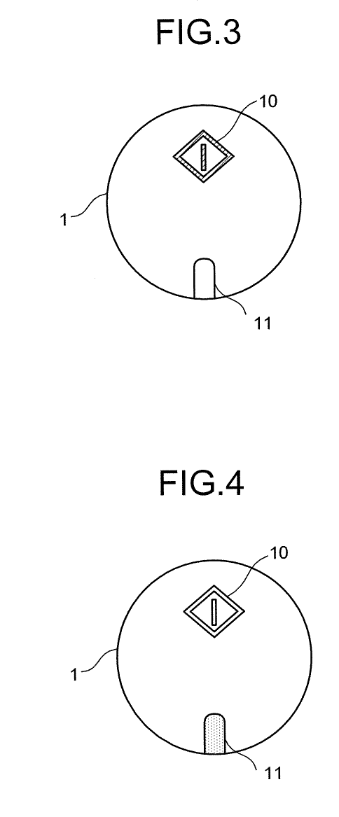

FIG. 2 is an enlarged view of the “START” key 1. The “START” key 1 includes two indicators 10 and 11. The indicator 10 contains a green light-emitting element. The green light-emitting element is arranged under a transparent or half-transparent cover so that a light of the green light-emitting element can be seen through the cover. The green light-emitting element is, for example, a light-emitting diode (LED) (a green LED 33 as shown in FIG. 8) having an emission wavelength in the range from 520 nanometers to 530 nanometers. When the indicator 10 lights up, it means that the image forming apparatus is “in a standby status or an operable status”. FIG. 3 depicts the “START” key 1 when the indicator 10 lights up. A shaded portion represents where a light of the green LED 33 is seen through the cover.

The indicator 11 contains a red light-emitting element. As with the indicator 10, the red light-emitting element is arranged under a transparent or half-transparent cover so that a light of the red light-emitting element can be seen through the cover. The red light-emitting element is, for example, an LED (a red LED 32 as shown in FIG. 8) having an emission wavelength in the range from 625 nanometers to 635 nanometers. When the indicator 11 lights up, it means that the image forming apparatus is “executing a job or in an inoperable status”. FIG. 4 depicts the “START” key 1 when the indicator 11 lights up. A dotted portion represents where a light of the red LED 32 is seen through the cover.

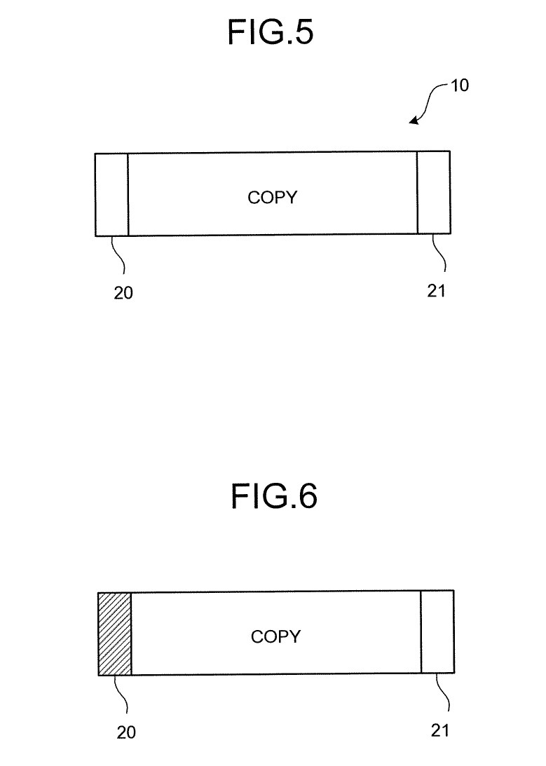

FIG. 5 depicts a “COPY” key of the mode select keys 2. The “COPY” key includes two indicators 20 and 21. The indicator 20 contains a green light-emitting element. The green light-emitting element is arranged under a transparent or half-transparent cover so that a light of the green light-emitting element can be seen through the cover. The green light-emitting element is, for example, an LED (the green LED 33) having an emission wavelength in the range from 520 nanometers to 530 nanometers. When the indicator 20 lights up, it means that “an operation mode (in this case, “COPY”) is selected and running properly”. FIG. 6 depicts the “COPY” key when the indicator 20 lights up. A shaded portion represents where a light of the green LED 33 is seen through the cover.

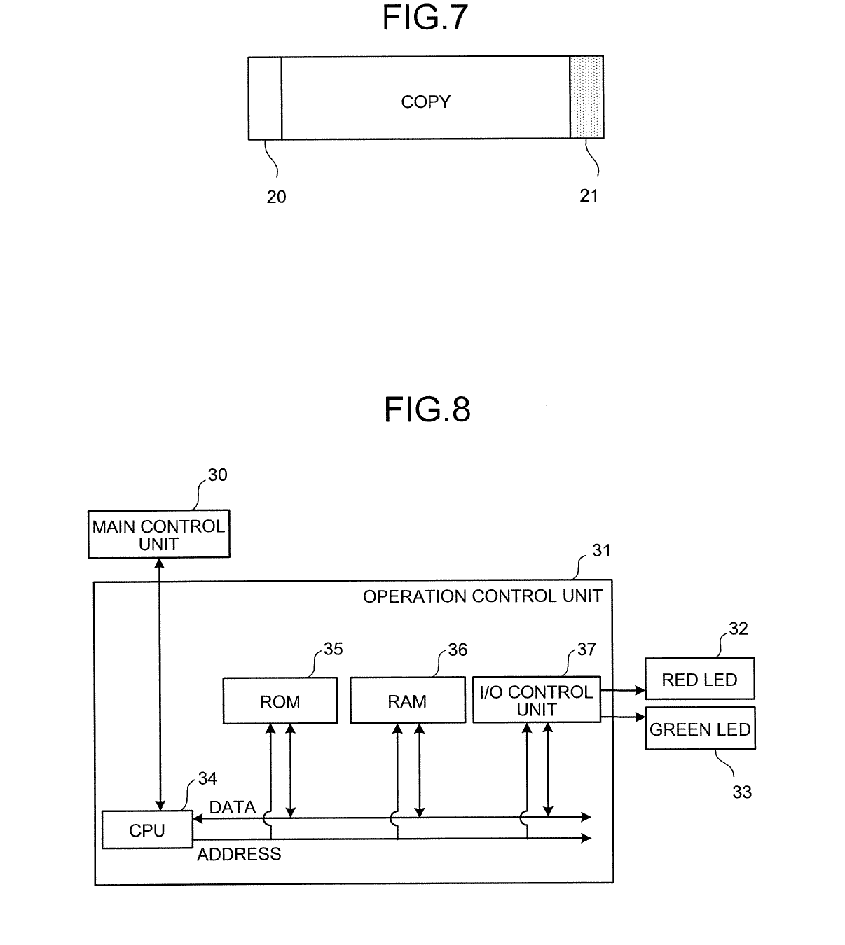

The indicator 21 contains a red light-emitting element. As with the indicator 20, the red light-emitting element is arranged under a transparent or half-transparent cover so that a light of the red light-emitting element can be seen through the cover. The red light-emitting element is, for example, an LED (the red LED 32) having an emission wavelength in the range from 625 nanometers to 635 nanometers. When the indicator 21 lights up, it means that “an error occurs while the image forming apparatus is executing the selected operation”. FIG. 7 depicts the “COPY” key when the indicator 21 lights up. A dotted portion represents where a light of the red LED 32 is seen through the cover.

As described above, in the image forming apparatus according to the embodiment, a user can easily recognize an occurrence of an error and an operation mode (“COPY”, “FACSIMILE”, “PRINTER”, or “SCANNER”) in which the error occurs. Moreover, the difference in wavelength between the green LED 33 and the red LED 32 is set to a predetermined value or more, which facilitates a person having color vision defects to recognize or distinguish light from the LEDs 32 and 33. Incidentally, the other keys of the mode select keys 2, i.e., a “FACSIMILE” key, a “PRINTER” key, and a “SCANNER” key, are of the same configuration as the “COPY” key, and only the “COPY” key is explained above as an example.

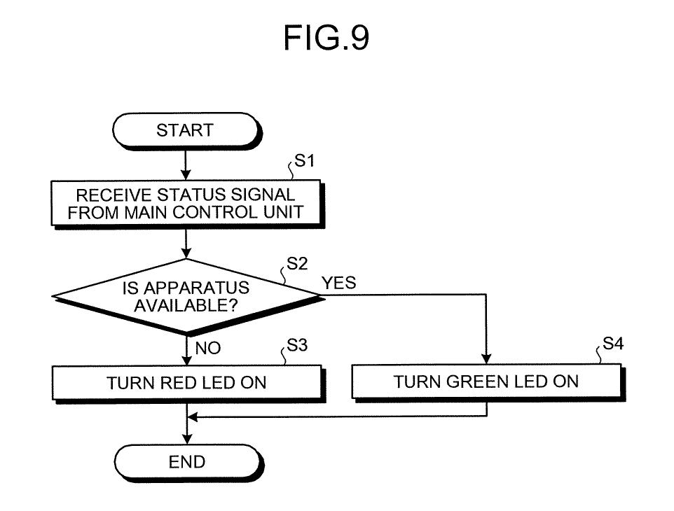

Operating procedures of the operation panel are described below with reference to FIGS. 8 and 9. FIG. 8 is a functional block diagram of an operation control unit 31. A main control unit 30 controls operations of the image forming apparatus, such as “COPY”, “FACSIMILE”, “PRINTER”, or “SCANNER”. The operation control unit 31 (the operation panel) includes a central processing unit (CPU) 34, a read-only memory (ROM) 35, a random access memory (RAM) 36, and an input/output (I/O) control unit 37. The CPU 34 controls the operation control unit 31. The ROM 35 stores therein computer programs according to which the CPU 34 operates. The RAM 36 serves as a work area for the computer programs stored in the ROM 35. The I/O control unit 37 drives the red LED 32 and the green LED 33, which are arranged inside the “START” key 1 and the mode select keys 2, to light up. The operation control unit 31 is connected to the main control unit 30 via a serial communication interface. The CPU 34 receives a status signal from the main control unit 30. Upon receiving a status signal, the CPU 34 determines, for example, whether a service is available, i.e., whether the image forming apparatus is available (in the standby status or the operable status), or not available (in the middle of a job or in the inoperable status), and the I/O control unit 37 drives the red LED 32 or the green LED 33 to light up depending on a result of the determination. Incidentally, as shown in FIG. 8, an address line is used for addressing of the status signal and the like, and a data line is used for passing of data among the CPU 34, the ROM 35, the RAM 36, and the I/O control unit 37.

FIG. 9 is a flowchart of an operation control process for driving the red LED 32 or the green LED 33 to light up. First, the CPU 34 receives a status signal of the image forming apparatus from the main control unit 30 (step S1). Based on the status signal, the CPU 34 determines whether the image forming apparatus is available (step S2). If the image forming apparatus is currently executing a job or in an inoperable status as, for example, the image forming apparatus is in warm-up mode for fixing, or is out of paper or toner, and is not available (NO at step S2), the CPU 34 transmits a signal indicating that the image forming apparatus is not available to the I/O control unit 37. Upon receiving the signal, the I/O control unit 37 turns the red LED 32 on (step S3).

If the image forming apparatus is in the operable status as, for example, in standby mode, and is available (YES at step S2), the CPU 34 transmits a signal indicating that the image forming apparatus is available to the I/O control unit 37. Upon receiving the signal, the I/O control unit 37 turns the green LED 33 on (step S4).

The operation control unit 31 continuously performs the above process at a predetermined cycle, for example, in cycles of 100 ms to 500 ms duration. Therefore, it is possible to light either the red LED 32 or the green LED 33 in response to a status signal, i.e., depending on a status of the image forming apparatus, appropriately. As a result, a user can easily recognize a status of the image forming apparatus.

As described above, according to the embodiment, because the difference in wavelength between the green LED 33 and the red LED 32 is set to a predetermined value or more, a person having color vision defects can distinguish between the green LED 33 and the red LED 32. Specifically, the red LED 32 is set to have an emission wavelength in the range from 625 nanometers to 635 nanometers, and the green LED 33 is set to have an emission wavelength in the range from 520 nanometers to 530 nanometers. Consequently, even if the indicator 10 that contains the green LED indicating “ready for operation” and the indicator 11 that contains the red LED indicating “not ready” are located close to each other or on the similar position, a person having color vision defects can distinguish between the green LED and the red LED. As for a user without color vision defects, both red-color and green-color have a recognizable wavelength, and thus the user can operate without feeling uncomfortable.

In the embodiment described above, the indicators 10 and 11 for indicating the availability of the image forming apparatus, and the indicators 20 and 21 for indicating a selected operation mode and execution status thereof are contained inside the keys in pairs (see FIGS. 2 and 5). The layout of the indicators is not limited to the above; the indicators can also be arranged, for example, outside the keys.

In the embodiment described above, while an LED is used for the indicators, such an LED is cited by way of example and without limitation. Alternatively, a liquid crystal display, an organic electroluminescence, a fluorescent display tube, and the like can be similarly used.

The light-emitting elements, which are used in pairs in the indicator for indicating apparatus status or operation-mode status, are set to emit light at wavelengths different by a predetermined amount or more. Thus, the operability of the image forming apparatus can be improved.

As set forth hereinabove, according to an aspect of the present invention, light-emitting elements used in pairs in each of indicators are set to have a predetermined degree of wavelength difference between them, and thus it is possible to provide a universally-designed display device and image forming apparatus.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display device comprising:
a display unit that displays a status of the display device; and
a plurality of light-emitting elements that is included in the display unit, and emits light at wavelengths different from one another by a predetermined amount.

2. The display device according to claim 1, wherein
the light-emitting elements includes a first light-emitting element and a second light-emitting element, and
the display unit includes
a first indicator that includes the first light-emitting element for indicating that the display device is available; and
a second indicator that includes the second light-emitting element for indicating that the display device is not available.

3. The display device according to claim 2, wherein
the light-emitting elements further includes a third light-emitting element and a fourth light-emitting element, and
the display unit further includes
a third indicator that includes the third light-emitting element for indicating a selected operation mode and sound operating status of the display device; and
a fourth indicator that that includes the fourth light-emitting element for indicating that an error occurs while the display device operates in the operation mode.

4. The display device according to claim 3, wherein the first light-emitting element and the third light-emitting element emit light of a color different from light emitted by the second light-emitting element and the fourth light-emitting element.

5. The display device according to claim 4, wherein the first light-emitting element and the third light-emitting element emit light of green.

6. The display device according to claim 4, wherein the second light-emitting element and the fourth light-emitting element emit light of red.

7. The display device according to claim 5, wherein the first light-emitting element and the third light-emitting element emit the light at a wavelength in a range from 520 nanometers to 530 nanometers.

8. The display device according to claim 6, wherein the second light-emitting element and the fourth light-emitting element emit the light at a wavelength in a range from 625 nanometers to 635 nanometers.

9. The display device according to claim 2, wherein the first indicator and the second indicator are located close to each other.

10. The display device according to claim 3, wherein the third indicator and the fourth indicator are located close to each other.

11. An image forming apparatus comprising a display device that includes
a display unit that displays a status of the display device; and
a plurality of light-emitting elements that is included in the display unit, and emits light at wavelengths different from one another by a predetermined amount.
